(19) United States
(12) Patent Application Publication
(10) Pub. No.: US 2006/0088017 A1
(43) Pub. Date: Apr. 27, 2006

(54) Mobile network system

(75) Inventors: Morihisa Kawai, Kawasaki (JP); Satoru Chikuma, Kawasaki (JP); Ikuo Takekawa, Kawasaki (JP); Teruhiko Onishi, Kawasaki (JP); Takeshi Saito, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/047,065

(22) Filed: Jan. 31, 2005

(30) Foreign Application Priority Data
Oct. 25, 2004 (JP) 2004-309772

(51) Int. Cl. H04L 12/56; H04L 12/28; H04Q 7/24

(52) U.S. Cl. 370/338

(57) ABSTRACT

In a communication system, which continues the communication while a mobile node moves over local networks, mobile IP system is used as a procedure of the mobile node moving over networks, and also the mobile node requests to the server (HA in the mobile IP) for the setting of data sent from the network such as a request for data-receiving time period and a request for compression of the receiving data and the server performs processing such as substitutional receiving of the data and transfer of the compressed data to the mobile node when not in the requested time period.

### BACKGROUND OF THE INVENTION

1. Field of the Invention

The present invention relates to a mobile network system.

2. Description of the Related Art

In recent years, hardware vendors produce terminal devices (laptop PC, PDA etc.) having various wireless communication interface such as PHS and wireless LAN built in. Also, the push type applications such as instant message draw public attention as new communication tools.

“Mobile” is a characteristic of the terminal, however when the terminal is moving and not connected to any network, the terminal cannot receive data provided by the push type applications or services.

In contrast, once the terminal is connected to the network, it has to receive data regardless of the characteristics of the network to which the terminal is connected, that of the data, or preference of the users.

In addition, communication speed and charging systems vary depending on networks, however the terminal cannot receive data which accords with characteristics of the network, which the terminal is connected to.

There is Non-patent Document 1, Patent Document 1, Patent Document 2, and Patent Document 3 describing the existing mobile network system. Non-patent Document 1 describes the background technology relating to seamless roaming. Patent Document 1 discloses an example of technology of substitutional reception of data by the LAN monitoring device and Patent Document 2 describes the data processing technology, which receives messages regardless of the type of network to which the terminal is connected. Patent Document 3 gives a description of the technology for database management of user information such as subscriber information and user preference.

Non-patent Document 1:

http://magazine.fujitsu.com/vol54-4/paper02.pdf

Patent Document 1:

Japanese Patent laid-open 2000-174822

Patent Document 2:

Japanese Patent laid-open 2002-540729

Patent Document 3:

Japanese Patent laid-open 2003-228583

A transmitting device cannot send data, nor a terminal receive data, when the terminal is not connected to the network.

The terminal must receive data from the transmitting device when the terminal is connected to the network.

The transmitting device is not informed even when the terminal cannot or did not receive data.

The terminal cannot receive data in accordance with the characteristic of the data sent from the transmitting device even after connecting to the network, in which the data from the transmitting device can be received.

The terminal cannot receive data from the transmitting device in accordance with personal data of the user using the terminal.

The data from the transmitting device cannot be compressed to a size suitable for the characteristics of the network to which the terminal is connected.

### SUMMARY OF THE INVENTION

It is an object of the present invention to provide a system to improve the convenience and reliability of communication, by utilizing information about the characteristics of the network to which a mobile node is connected and information about users using the mobile node.

Firstly, the mobile network system of the present invention, in which a mobile node moves over networks comprising servers, performs communication over the networks. The mobile node comprises a means for detecting movement of the mobile node in the network and a means for processing, which enables the mobile node to communicate with the destination network, and for setting information unique to the mobile node at the server in order to receive the data over the destination network. When the mobile node receives data from the destination network, the mobile node receives data from the server according to the information unique to the mobile node.

Secondly, the mobile network system of the present invention, in which a mobile node moves over networks comprising servers, performs communication over the networks. The server comprises a means for managing the network information, personal data of the user using the mobile node and characteristics of the reception data and for managing the network information, personal data of the user using the mobile node and characteristic of the reception data by the mobile node upon data reception when the mobile node moves over networks. The server also comprises means for receiving reception condition dataunique to the mobile node requesting data from the server based on the above information and for transmitting the data to the mobile node based on reception condition information on the managing means.

A transmitting device can send data to a mobile node regardless of the network the mobile node is connected to or when the mobile node is not connected.

The transmitting device can confirm that the mobile node has received the transmitted data

The mobile node can receive data, which is sent while the mobile node is disconnected from the network.

The mobile node can receive data in accordance with the characteristics of the data sent by the transmitting device, personal data and information of network to which the user is connected.

The mobile node can receive the data, sent by the transmitting device, in the size appropriate to the characteristics of the network to which the mobile node is connected.

### BRIEF DESCRIPTION OF THE DRAWINGS

FIG. 1 is a diagram showing the configuration of the system to which the embodiments of the present invention is applied.

FIG. 2 is a functional block diagram of software installed on the mobile node.

FIG. 3 is an example of the network information stored in the mobile node.

FIG. 4 is an example of the personal data stored in the mobile node.

FIG. 5 is a functional block diagram of the software installed on the server.

FIG. 6 is an example of the mobile node data, which the server stores.

FIG. 7 is diagram 1 describing the process flow of first embodiment of the present invention.

FIG. 8 is diagram 2 describing the process flow of first embodiment of the present invention.

FIG. 9 is diagram 1 describing the process flow of second embodiment of the present invention.

FIG. 10 is diagram 2 describing the process flow of second embodiment of the present invention.

FIG. 11 is diagram 1 describing the process flow of third embodiment of the present invention.

FIG. 12 is diagram 2 describing the process flow of third embodiment of the present invention.

FIG. 13 is diagram 1 describing the process flow of fourth embodiment of the present invention.

FIG. 14 is diagram 2 describing the process flow of fourth embodiment of the present invention.

FIG. 15 is diagram 1 describing the process flow of fifth embodiment of the present invention.

FIG. 16 is diagram 2 describing the process flow of fifth embodiment of the present invention.

FIG. 17 is diagram 3 describing the process flow of fifth embodiment of the present invention.

FIG. 18 is diagram 4 describing the process flow of fifth embodiment of the present invention.

### DESCRIPTION OF THE PREFERRED EMBODIMENTS

The system of the preferred embodiment of the present invention comprises a mobile node, a server, a transmitting device that communicates with a mobile node, and a program to communicate with the server. In such a system, the mobile node has management function of information of the characteristics of the network to which it is connected and the personal data (service setting data) of the users who use the mobile node and the mobile node (MN) function in the mobile IP. The server stores information of the characteristics of the network to which the mobile node is connected, the management function of the personal data of the user using the terminal information device, the management function of the received data characteristic and home agent (HA) function in the mobile IP. When the mobile node is registered according to the mobile IP, the mobile node also conveys information about the network to which the mobile node is currently connected and information for the user using the mobile node.

Utilizing the mobile IP system, the server obtains the information about the network to which the mobile node is connected and data for the user who uses the mobile node periodically or on demand from the mobile node.

The server receives the data substituting for the mobile node when there is no information or response from the mobile node, which might be because the mobile node is disconnected from the network, or because the communication speed of the connected communication media is slow or it is not during the requested data receiving period, which is determined from the information and the response data from the mobile terminal and the data characteristic from the transmitting device. As soon as the terminal information device is restored to the data-receiving or data-receivable status, the server sends the data to the mobile node.

Also, the server receives data substituting for the mobile node and conveys information of the substitution reception to the transmitting device and the mobile node. In addition, at the point when the mobile terminal is restored to the data-receiving or data-receivable status, the server sends the data to the mobile node, and conveys information of the data transmission to the mobile node to the transmission information device.

When the mobile terminal is considered to be disconnected from the network and when data that requires real-time communication is transmitted from the transmitting device, the server performs substitutional receiving for the mobile node and conveys information that the mobile node cannot receive the data to the transmitting device.

Moreover, the program requests information as to which network the mobile node is connected, managed by the server, and the personal data for the user who uses the terminal information device, the server responds to the request. In addition, information about the network to which the mobile node is connected, managed by the server and information for the user who uses the mobile node are conveyed to the program upon changing the management information along with any movement of the mobile node.

Also, the server sends the data, transmitted by the transmitting device, to the program, which acquired the information about the network to which the mobile node is connected. The program applies the data compression process most suitable for the characteristics of the network that the mobile node is connected to and sends back the data to the server. The server transfers the compressed data to the mobile node by utilizing the mobile IP system.

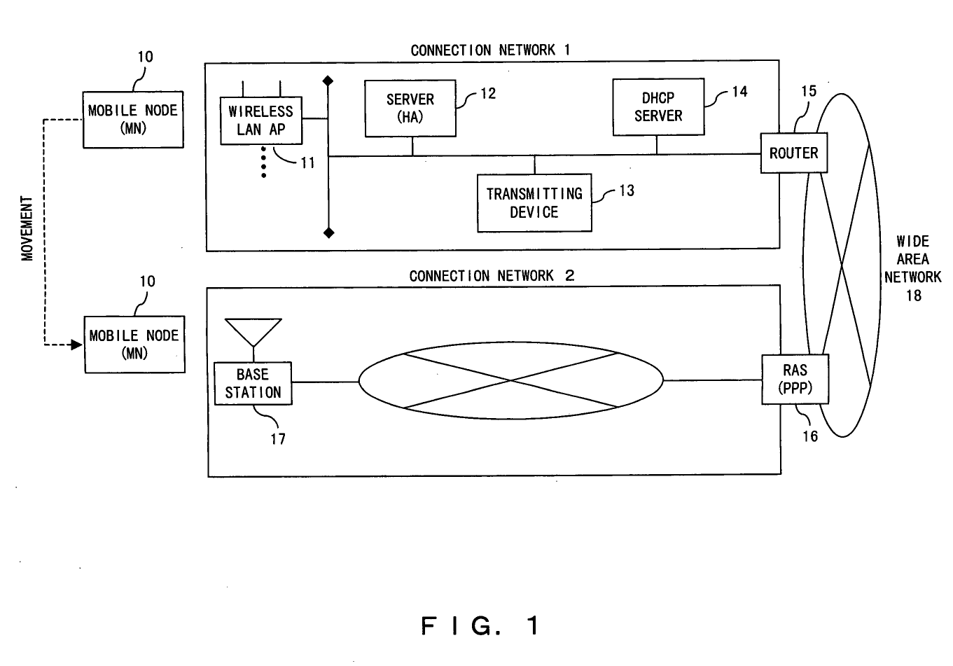

FIG. 1 shows the configuration of the system to which the embodiment of the present invention is applied.

In FIG. 1, the mobile node (MN) can be equipped with a plurality of communication interfaces, and has information about connection networks 1 and 2, the management function of the personal data for the user using the mobile node and the MN (Mobile Node) function of mobile IP.

A server 12 comprises information about the connection network to which a mobile node 10 is connected, the management function of the personal data for the user using the mobile node 10, the management function of the characteristics of received data and the HA (Home Agent) function of the mobile IP.

The program running on the server responds with information about the connection network to which the mobile node 10, which is under the control of the server and the personal data for the user using the mobile node 10, or provides an API (Application Program Interface), which conveys information about the network to which the mobile node is connected and data for the user using the mobile node upon change of the management data caused by movement of the mobile node 10.

Transmitting end terminal 13 has a function providing push type services.

A connection network 1 comprises a wireless LAN access point, and connection network 2 is a network for remote access by dial-up using a mobile phone. Each connection network forms one subnet, and assigns IP addresses to the terminal information device by protocols such as DHCP (Dynamic Host Configuration Protocol) and PPP (Point to Point Protocol).

The mobile node 10 wirelessly accesses wireless LAN access point 11 or a base station 17. The connection network 2, which includes the base station 17, is connected to a wide area network 18 through a PPP RAS (Remote Access Server). The connection network 1 comprises the wireless LAN access point 11, server 12, the transmitting device 13 and DHCP 14, and is also connected to the wide area network 18 through a router 15.

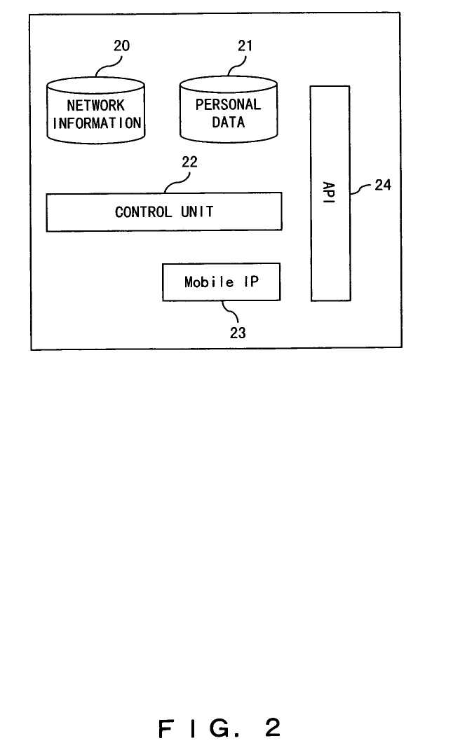

FIG. 2 is a functional block diagram of software installed on the mobile node.

Network information 20 and personal data 21 (network setting data for the user, who owns the mobile node) are stored in the mobile node. Functionally, the mobile node comprises a control unit 22, which controls the mobile node, a mobile IP control unit 23, which controls the mobile IP and an application program interface 24.

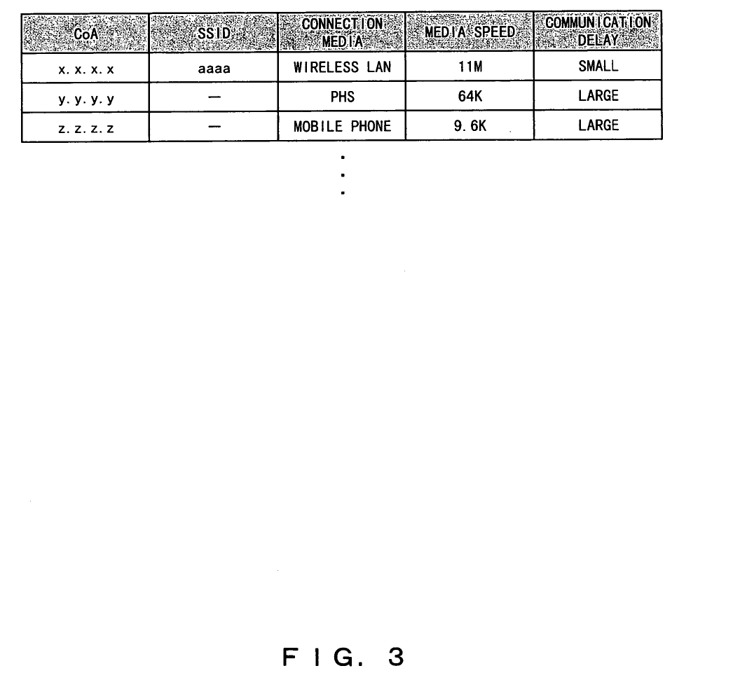

FIG. 3 is an example of the network information stored in the mobile node. In FIG. 3, the network information is shown as a table. The network information table stores care of address, SSID (service set ID), connection media, communication speed of the media, and communication delay.

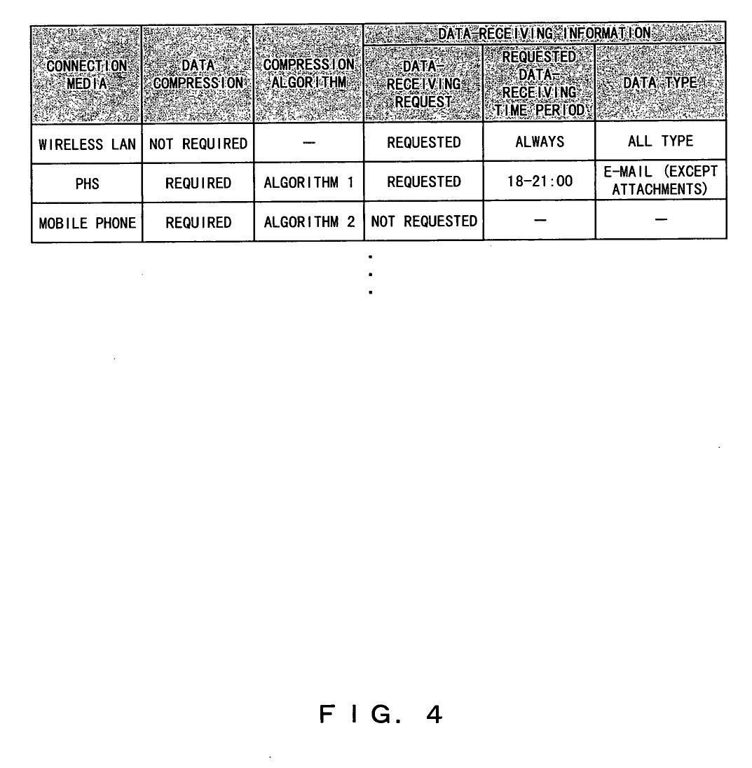

FIG. 4 is an example of the personal data stored in the mobile node.

In FIG. 4, the personal data (personal setting data for network service) is shown as a table. The personal data table stores connection media, data compression status, data compression algorithm, and data receiving information such as the data-receiving request, requested data-receiving time period, and types of data.

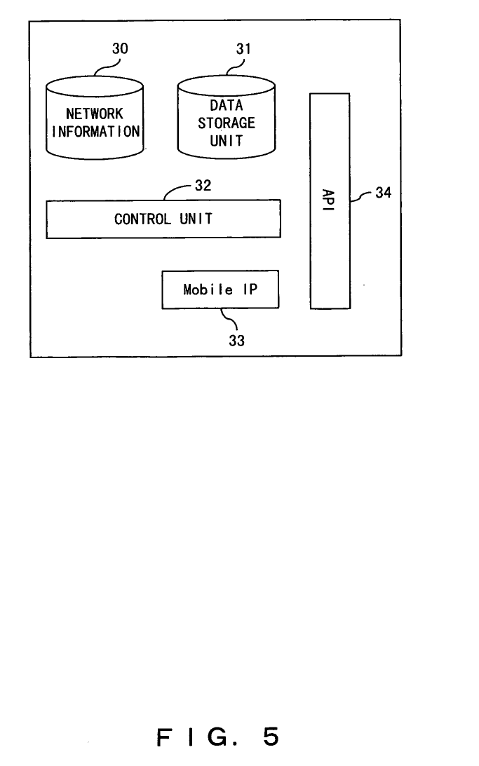

FIG. 5 is a functional block diagram of the software installed on the server.

The server stores mobile node data 30 and data of data storage unit 31. Also, the server comprises a control unit 32, which controls the server, mobile IP control unit 33, which realizes the mobile IP function and application program interface 34.

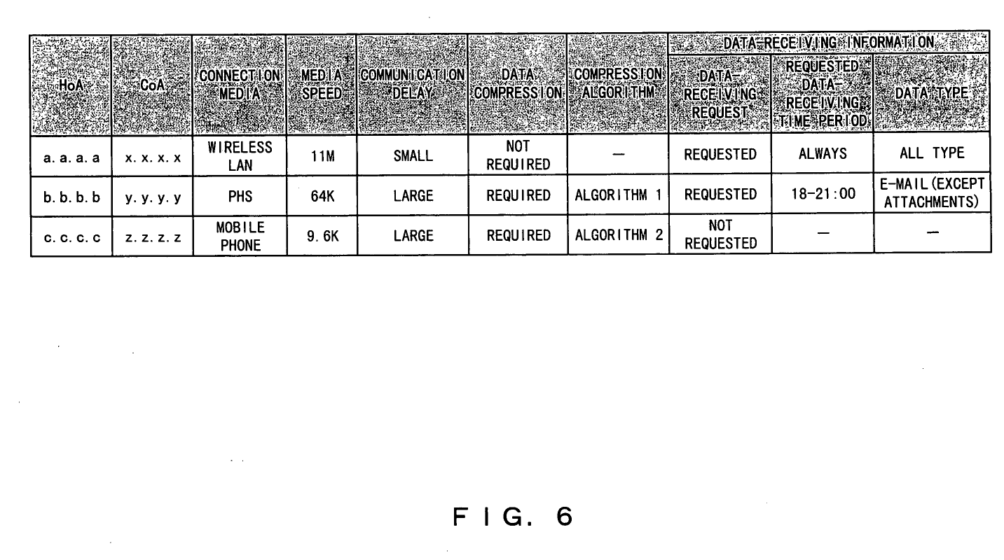

FIG. 6 is an example of the mobile node data, which the server stores.

In FIG. 6, the mobile node data is shown as a table. The mobile node data table comprises home address (HoA), care of address (CoA), connection media, communication speed of the media, communication delay, data compression availability, compression algorithm, and the data-receiving information such as the data-receiving request, requested data-receiving time period, and the data types.

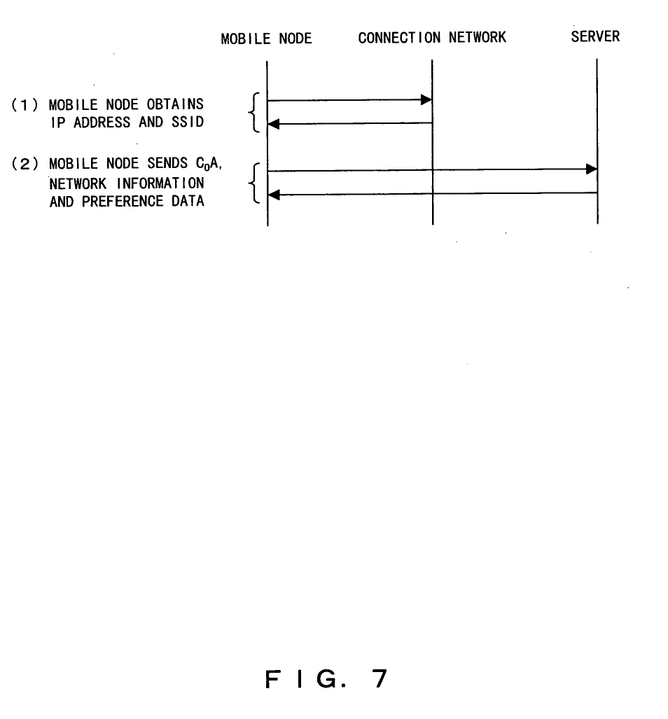

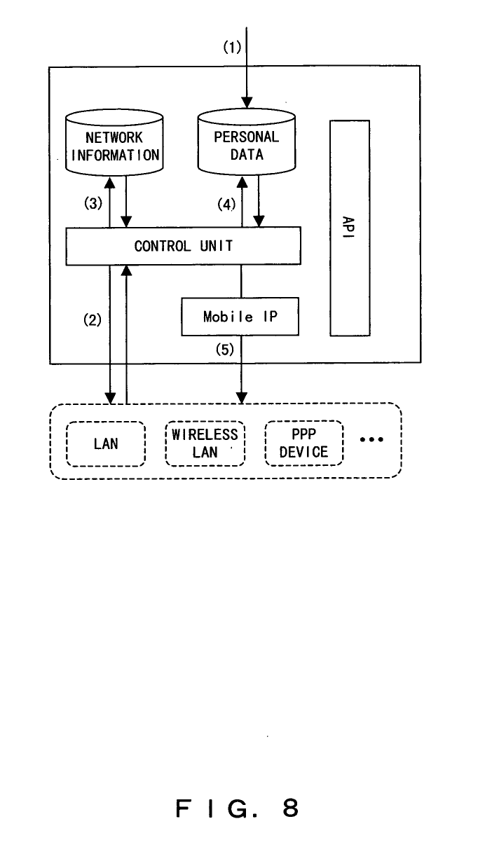

FIG. 7 and FIG. 8 are diagrams describing the process flow of first embodiment of the present invention. The mobile node's IP address is assigned from network it is connected to every time when the mobile node starts up and moves to a different network and/or switches communication media and when an apparent attempt to connect to the network is initiated by the user. The terminal information device, which acquired the IP address, registers itself with the server. Upon registration with the server by the mobile IP function, the terminal information device registers information about the network, to which the terminal information device is connected and personal data for the user, who uses the terminal information device with the server.

According to the sequence chart in FIG. 7, first, communication is established between the mobile node and the connection network, and the mobile node obtains an IP address and SSID from the connection network (1). Next, the mobile node communicates with the server and sends the CoA of the mobile node, network information, and the personal data to the server (2).

FIG. 8 is a chart describing the internal processes of the mobile node. First, personal data, such as a request for data compression from the data-receiving user and requested time period for receiving data are input to the mobile node (1). Next, the mobile node detects movement (transfer subnets) from change in IP address or SSID by communication between the network and control unit (2). And the mobile node specifies the network information such as connection media and media speed from the obtained IP address and SSID (3), then specifies personal data from the network information such as connection media (4), and sends the mobile node CoA, network information, and personal data to the server using the mobile IP function (5).

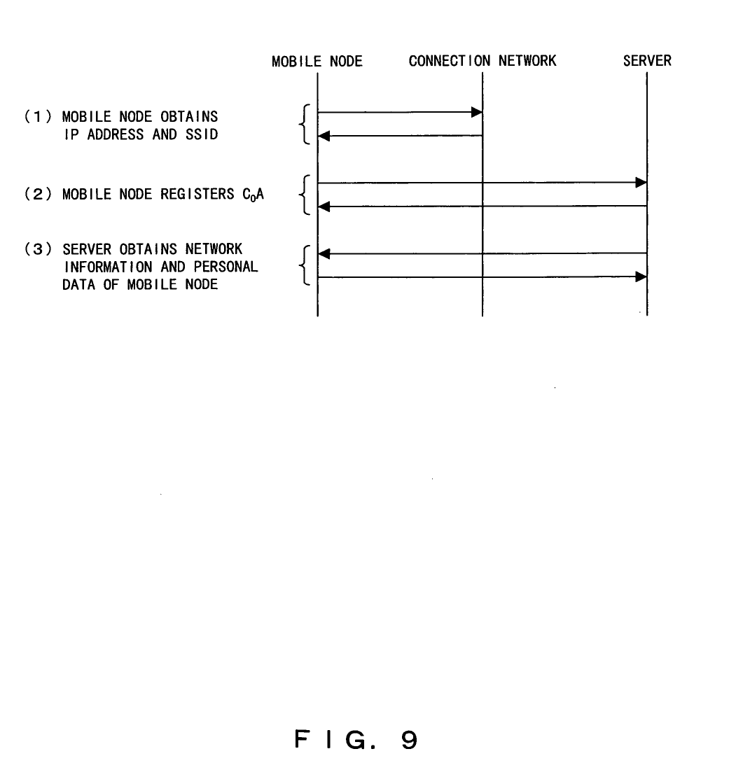

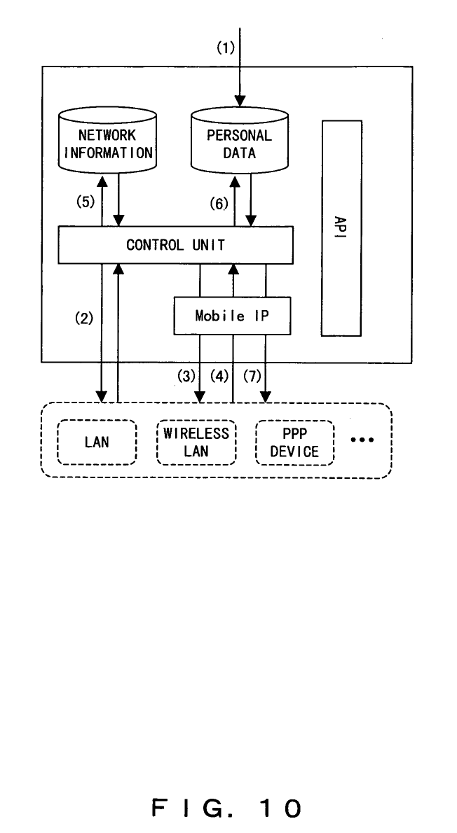

FIG. 9 and FIG. 10 are diagrams describing the process flow of a second embodiment of the present invention. The mobile node has the IP address assigned by the network it is connected to every time the mobile node starts up or moves to a different network and/or switches communication media or when an apparent attempt to connect to the network is initiated by the user. The terminal information device, which acquired the IP address, registers itself with the server. Upon registration with the server by the mobile IP function, the terminal information device registers information about the network, to which the terminal data device is connected and personal data for the user, who uses the terminal data device with the server.

According to the sequence chart of FIG. 9, communication between the mobile node and connection network is established and the IP address of the mobile node and SSID are acquired (1). Next, the mobile node establishes communication with the server, and registers the CoA of the mobile node (2). The server obtains the network information of the mobile node and the personal data through communication between the mobile node and the server (3).

FIG. 10 shows that a user, first, inputs the personal data such as the option of data compression and requested data receiving time period (1). The control unit of the mobile node establishes communication with the network the mobile node is connected to, and detects the movement of the mobile node (transfer subnets) from the change in IP address and SSID (2). Next, the control unit registers the CoA of the mobile node using the mobile IP function (3). The control unit receives a request for network information and the personal data of the mobile node from the server (HA) (4), specifies network information such as connection media and media speed from the obtained IP address and SSID (5), specifies the personal data from the network information such as connection media (6), and sends the network information and personal data to the server (7).

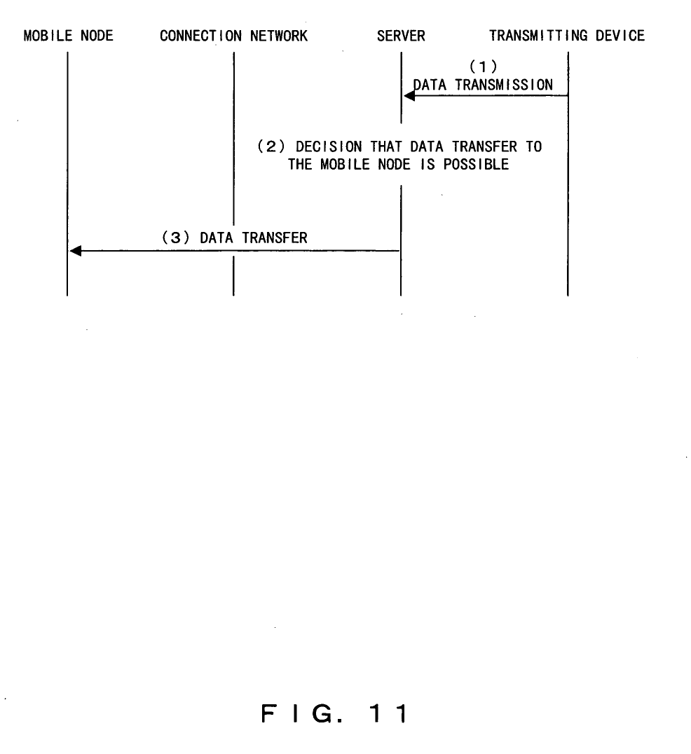

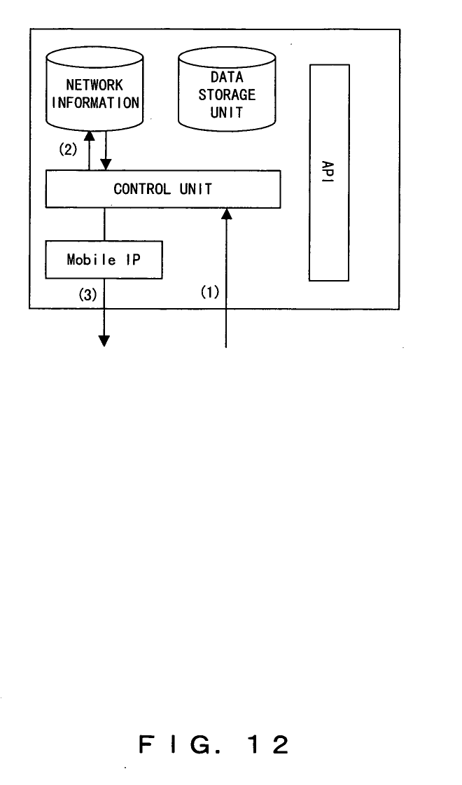

FIG. 11 and FIG. 12 are diagrams describing the process flow of the third embodiment of the present invention.

The transmitting device transmits the data to the home address of the mobile node. Using the mobile IP function, the server receives the data, substituting for the mobile node. Based on the information, obtained from the mobile node, about the network to which the mobile node is connected and the personal data for the user who uses the mobile node, and in addition, the characteristics of data transmitted from the transmitting device, the server determines the data transfer to the mobile node, and transfers the data.

According to FIG. 11, the data transmitted by the transmitting device to the mobile node is first received by the server (1). And, from the personal data, which the server obtained from the mobile node in advance, it is determined whether it is the data-receiving time period that the user requested or not and whether the data compression is needed or not. Based on the above determinations, it is decideded whether the data transfer to the mobile node is possible or not (2). When it is determined that the data transfer is possible, the data is transferred from the server to the mobile node over the network (3).

FIG. 12 is a diagram showing the internal processing of the server (HA).

First, the data from the transmitting device is received by the control unit which substitutes for the mobile node (1). With reference to the registered MN data, the data transfer is determined (2). Using the mobile IP control unit, the control unit transfers the data to the mobile node (MN).

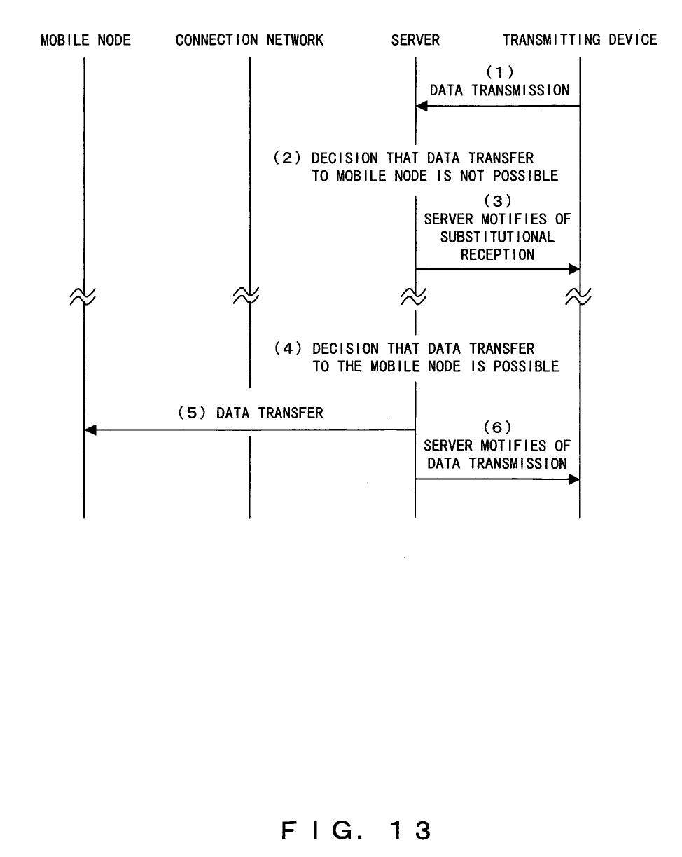

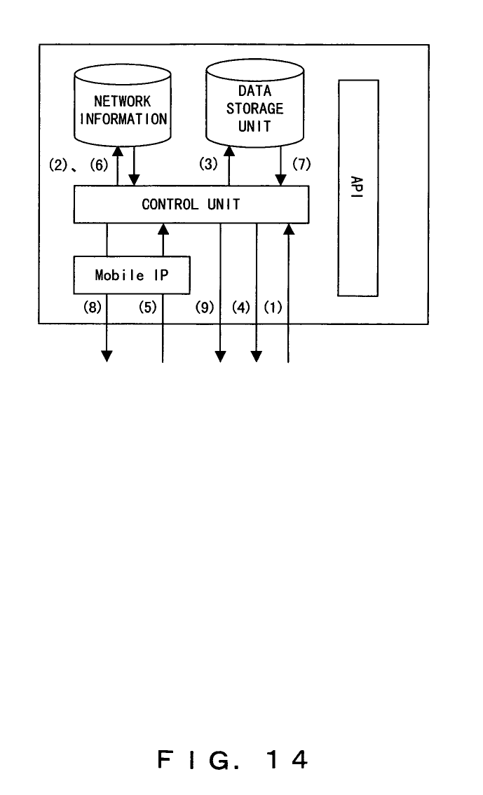

FIG. 13 and FIG. 14 are charts describing the process flow of the forth embodiment of the present invention. The transmitting device sends the data to the home address of the mobile node. Based on the information, obtained by the same means as the embodiments described above, of the network to which the mobile node is connected and the personal data of the user who uses the mobile node, and data characteristic transmitted from the transmitting device, the server determines the data suspension state and conveys the information that the server received the data substituting for the mobile node and that the data cannot be transferred to the mobile node.

The server determines data transfer to the mobile node based on the information about the network connected to the mobile node, which is updated by the same means as the embodiments described above, and the personal data for the user using the mobile node. Upon the transfer of the data to the mobile node using the mobile IP system, the information about data transfer to the mobile node is conveyed to the transmitting device.

According to FIG. 13, first, data is transmitted from the transmitting device to the mobile node, however the data is received by the server (1). When the server determines that data transfer to the mobile node is not possible, it notifies the transmitting device (3) of reception. At that time, as the need arises, the server updates the network information and personal data. When the server determines that data transfer to the mobile node is possible (4), it transfers the data to the mobile node (5) and notifies the transmitting device (6) of the data transmission.

FIG. 14 is a diagram showing the internal processes of the server (HA). First, the server receives the data from the transmitting device, substituting for the mobile node (1), and determines the suspension of the data transfer with reference to the registered MN data (2). The suspended data is stored in a data suspension unit (3). Information about the data suspension is sent to the transmitting device (4). According to the information from the mobile node (MN) data, the CoA, the network information, and the personal data are updated (5). With reference to the updated MN data, it is determined to transfer data (6). The server obtains the stored data for the data transfer (7), sends the data to the mobile node (8), and conveys the data transfer information to the transmitting device (9).

It is possible to establish a system such that the application program implemented by the server requires the network information to which the mobile node is connected and the personal data for the user using the mobile node through the API (Application Program Interface) provided by the server.

In response to the request of the server application program, the mobile node supplies the network information of which the mobile node is connected and the personal data for the user using the mobile node.

Upon the change in management information along with movement of the mobile node, the network information to which the mobile node is connected and the personal data for the user using the mobile node, received by the server, are conveyed to the application program.

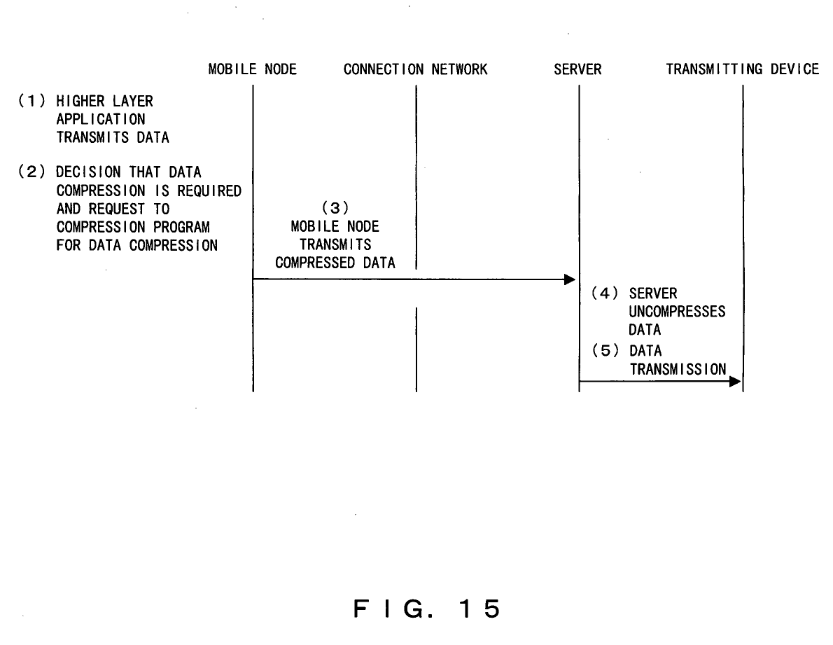

FIG. 15 through FIG. 18 are diagrams indicating the process flow of the fifth embodiment of the present invention.

The transmitting device sends data to the home address of the mobile node. Using the mobile IP function, the server receives data substituting for the mobile node. The server determines the need for data compression from the network information to which the mobile node is connected, obtained by means described in the first or the second embodiment, the personal data for the user using the mobile node and the characteristics of the data sent by the transmitting device, and sends the data to the compression program.

The application program obtains the network information for the network to which the mobile node is connected and the personal data for the user using the mobile node, applies a data compression algorithm appropriate for the network characteristic to which the mobile node is connected, and returns the data to the server.

The server transfers the compressed data to the terminal information device, using the mobile IP function.

When the mobile node in FIG. 15 sends the data, first, the application in a higher layer of the mobile node sends the data (1), next, the requirement of data compression is applied and data compression is requested of the compression program (2). Next, the compressed data is sent from the mobile node to the server (3), the sever uncompresses the data (4) and sends the data to the transmitting device (5).

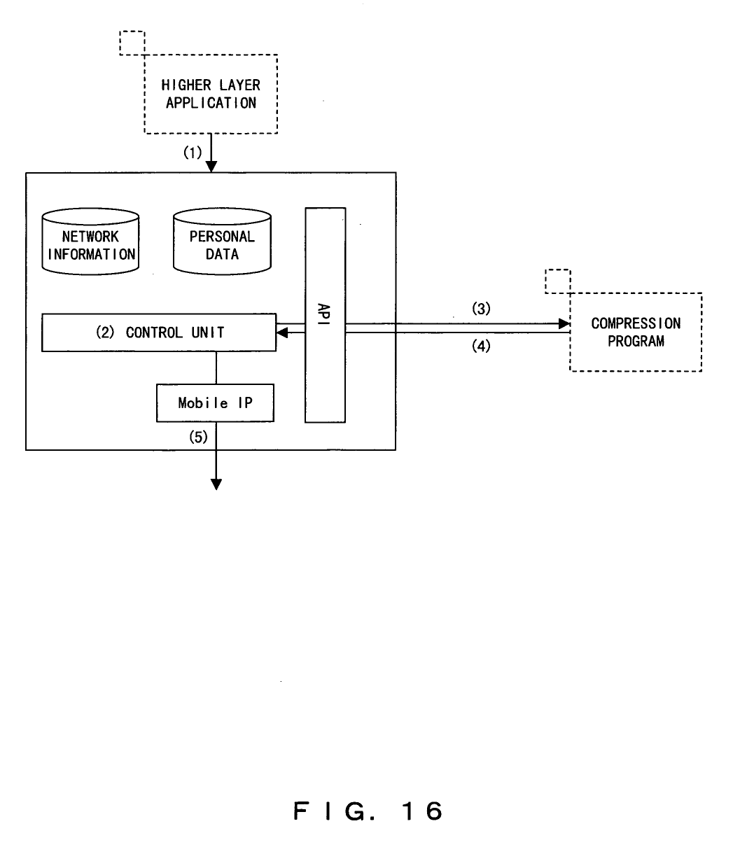

According to the internal processing of the mobile node in FIG. 16, first, the data from the higher layer application is received (1). Then the control unit determines the data compression based on the network information and the personal data (2), and sends the data, which is to be compressed, and the data of the selected compression algorithm to the compression program through the API (3). Here, there is a plurality of compression programs. The compression program, which receives the data for compression, compresses the data and sends the compressed data to the control unit (4). The control unit sends the compressed data to the server using the mobile IP function.

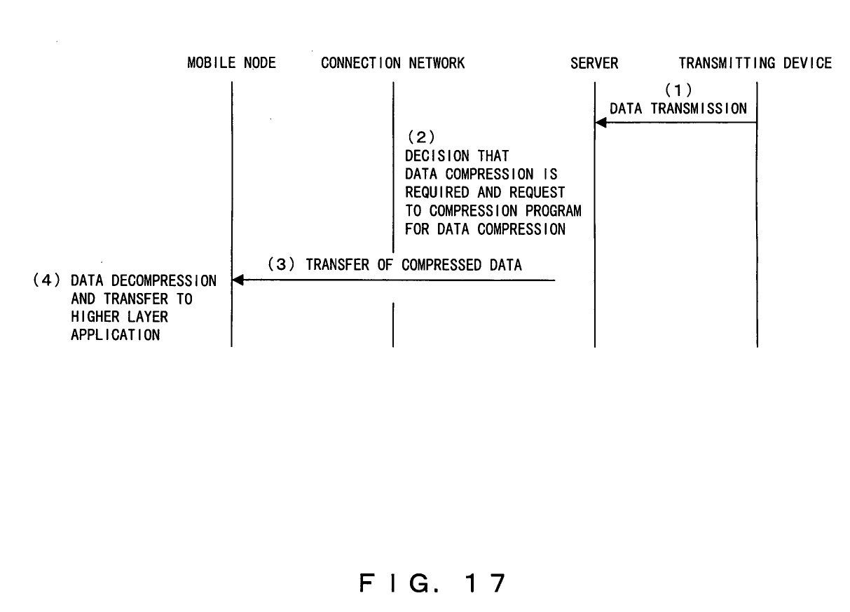

When the transmitting device sends the data, as it is described in FIG. 17, first, the transmitting device sends the data to the home address, the server receives the data substituting for the mobile node using the mobile IP function (1). Next, when data compression is required, the server instructs the compression program to compress the data (2), and transfers the compressed data to the mobile node (3). At the mobile node, the compressed data is uncompressed and transferred to the higherlayer application (4).

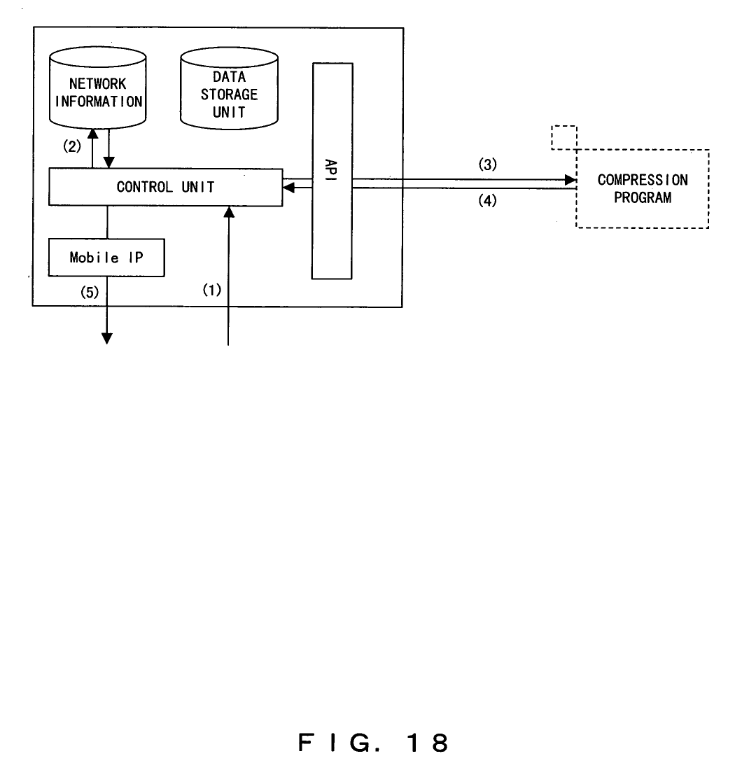

According to the server operation in FIG. 18, the server receives the data substituting for the mobile node from the transmitting device (1), checks the data HoA and the MN data and determines whether the data should be compressed or not (2). The data to be compressed and the selected compression algorithm are sent through the API (3), receives the compressed data from the compression program (4) and transmits the compressed data to the mobile node (5).

What is claimed is:

1. A mobile network system, in which a mobile node moves over networks comprising servers, performs communication over the networks, and the mobile node comprising:
a unit for detecting movement of the mobile node in the network; and
a setting unit for performing a process which enables the mobile node to communicate with a destination network, and for setting information unique to the mobile node at the server in order to receive the data over the destination network, wherein
when the mobile node receives data over the destination network, the mobile node receives data from the server according to the information unique to the mobile node.

2. The mobile network system according to claim 1, wherein
the mobile node comprises:
a management unit for managing network information including information of at least one among media types, communication speed and accounting system
a personal data management unit for managing personal data for the user using the mobile node including at least one among the data of requested time period for data reception and content type of the requested data,
and sets information unique to the mobile node at the server, based on the information managed by the management unit and the personal data management unit, on connecting to the network or on moving to an other network.

3. The mobile network system according to claim 1, wherein
The movement of the mobile node is detected by a change in IP address or SSID, and processing for establishing communication with the destination network is in accordance with mobile IP processing

4. The mobile network system according to claim 1, wherein
The information unique to the mobile node contains at least one of data compression request, declaration on data receiving limited to a specific time period or request for substitutional receiving of the data.

5. A mobile network system, in which a mobile node moves over networks comprising servers, performs communication over the subnet, and the server comprising:
a management unit for managing the network information, personal data for the user using the mobile node and characteristic of the received data;
a management unit for managing the network information, personal data of the user using the mobile node and characteristic of the receiving data by the mobile node in data receiving when the mobile node moves over networks;
an information receiving unit for receiving data of the reception conditions unique to the mobile node requesting to the server based on the information managed by both of the management units; and
a transmission unit for transmitting data to the mobile node based on information on the managing means following the received conditions.

6. The mobile network system according to claim 4, wherein
the server comprises a plurality of types of application programs for processing to meet the conditions sent from the mobile node, and chooses an appropriate application program among the plurality of types of application programs according to information unique to the mobile node.

7. The mobile network system according to claim 6, wherein
an application program interface is used for using the application program.

8. The mobile network system according to claim 6, wherein
the application program is a data compression program.

9. The mobile network system according to claim 4, wherein
the conditions comprise at least one of data compression request, declaration on data receiving limited to a specific time period or request for substitutional receiving of the data.

10. The mobile network system according to claim 9, wherein
the server sends a message notifying transmitting device of the substitutional reception of the data, when the server performed substitutional reception of the data.

11. The mobile network system according to claim 10, wherein
the server sends the data, received in substitution for the mobile node, to the mobile node when the mobile node comes to be in the data-receiving status, and sends a message notifying the transmission of the data to the mobile node, to the transmitting device.

12. A communication control method in a mobile network system, in which a mobile node moves over networks comprising servers, performs communication over the networks, and the method of the mobile node comprising:
detecting the movement of the mobile node over networks; and
setting the server for the information unique to the mobile node required for the data receiving over the destination network as well as the processing to establish the communication with the destination network, wherein
when the mobile node receives the data from the destination network, the mobile node receives the data from the server according to the information unique to the mobile node.

13. A communication control method in a mobile network system, in which a mobile node moves over networks comprising servers, performs communication over the networks, and the method of a server comprising:
receiving conditions requested to the server from the mobile node in data receiving when the mobile node moves over networks; and
transmitting the data to the mobile node according to the received information unique to the mobile node.

14. A storage media storing a program, which makes a computer realize a communication control method in a mobile network system, in which a mobile node moves over networks comprising servers, performs communication over the networks, and the method of the mobile node comprising:
detecting the movement of the mobile node over networks; and
setting the server for the information unique to the mobile node required for the data receiving over the destination network as well as the processing to establish the communication with the destination network.

15. A storage media storing a program, which makes a computer realize a communication control method in a mobile network system, in which a mobile node moves over networks comprising servers, performs communication over the networks, and the method of a server comprising:
receiving information unique to the mobile node requested to the server from the mobile node in data receiving when the mobile node moves over networks; and
transmitting the data to the mobile node according to the received information unique to the mobile node.
